(19) United States
(12) Patent Application Publication
(10) Pub. No.: US 2011/0231345 A1
(43) Pub. Date: Sep. 22, 2011

(54) Textile Marking & Textile Ownership Registration

(76) Inventors: Jeff Van Le, Panorama City, CA (US); Natalie Huynh Le, Panorama City, CA (US)

(21) Appl. No.: 13/095,065

(22) Filed: Apr. 27, 2011

Related U.S. Application Data
(63) Continuation-in-part of application No. 12/005,072, filed on Dec. 26, 2007.

(51) Int. Cl. G06Q 90/00

(52) U.S. Cl. 705/500

(57) ABSTRACT

The present invention relates to the field of textile marking and textile ownership registration. More specifically, the present invention relates to a method of marking a textile model insignia onto a textile article and a method of textile ownership registration with the help of a textile ownership ID or a textile ID. An object of the present invention is to indicate the price range of a textile article by displaying a textile model insignia. Another object of the present invention is to enable textile ownership registration with the display of a textile ownership ID or a textile ID.

### CROSS REFERENCE TO RELATED APPLICATION SER. NO. 12/005,072

This new patent application is a Continuation-in-Part (CIP). Claim for priority is requested for the existing application Ser. No. 12/005,072, titled “Textile Model Insignia”, and filing date Dec. 26, 2007.

### REFERENCES CITED

Referenced By

### U.S. Patent Documents

| Document Number | Date | Name | Classification |
|---|---|---|---|
| 1,173,927 | February 1916 | Burns | |
| U.S. Pat. No. 1,338,074 A | April 1920 | Eames George M et al. | 112/462 |
| 1,741,620 | December 1929 | Fixler | |
| U.S. Pat. No. 1,815,021 A | July 1931 | Louis Bland | 101/123 |
| U.S. Pat. No. 2,062,933 A | September 1936 | Nathan Louft | 428/478.8 |
| U.S. Pat. No. 2,314,913 A | March 1943 | Weiller Herbert A | 101/128.4 |
| U.S. Pat. No. 2,374,524 A | April 1945 | Clair Bowers Ernest | 101/128.4 |
| U.S. Pat. No. 2,429,986 A | November 1947 | Clair Bowers Ernest | 428/206 |
| U.S. Pat. No. 2,747,501 A | May 1956 | Latimer Herbert C | 101/114 |
| 3,040,332 | June 1962 | Kleinwald | |
| 3,525,104 | August 1970 | Bonanno | |
| 4,325,999 | April 1982 | Campman | |
| 4,427,472 | January 1984 | Trager | |
| 4,837,864 | June 1989 | Thill | |
| 5,007,113 | April 1991 | Bouadjadja | |
| 5,099,773 | March 1992 | Codos | |
| 5,241,919 | September 1993 | LaGreca | |
| 5,544,365 | August 1996 | Mondy | |
| 5,800,900 | September 1998 | Mitchell | |
| U.S. Pat. No. 6,083,656 A | July 2000 | Hare et al. | 430/138 |
| U.S. Pat. No. 6,289,831 B1 | September 2001 | Hare et al. | 112/102.5 |
| U.S. Pat. No. 6,457,428 B1 | October 2002 | Victory, Bryan K. | 112/103 |
| US-2008/194855 A1 | August 2008 | Gottchalk-Gaudig et al. | 556/407 |
| U.S. Pat. No. 3,657,060 A | April 1972 | Haigh, Thomas I. | 428/175 |
| U.S. Pat. No. 4,089,722 A | May 1978 | Holoubek, Verne Richard | 156/235 |
| U.S. Pat. No. 5,009,943 A | April 1991 | Stahi, Ted | 428/40.6 |
| U.S. Pat. No. 6,194,044 B1 | February 2001 | Stahi, Ted A. | 428/40.1 |

### Foreign Patent Documents

| Document Number | Date | Name | Classification |
|---|---|---|---|
| 52665 | March 1985 | JP | |

### FIELD OF THE INVENTION

The present invention relates to the field of textile marking and textile ownership registration. More specifically, the present invention relates to a method of marking a textile model insignia onto a textile article and a method of textile ownership registration with the help of a textile ownership ID or a textile ID.

A method of marking a textile model insignia onto a textile article of the present invention is described, firstly, as creating various price ranges and various textile model insignias, secondly, as creating an index to assign and to pair a different textile model insignia to each and every price range for correlation, thirdly, as identifying the price range that the price of a certain textile article falls within, fourthly, as identifying the textile model insignia that is correlated to such a price range, and, finally, as marking such a textile model insignia onto such a textile article and each and every other textile article, in which its price falls within such a price range that is correlated to such a textile model insignia.

A method of textile ownership registration of the present invention is described, firstly, as creating a textile ownership ID, secondly, as assigning such a textile ownership ID to a certain textile article, thirdly, as marking such a textile ownership ID onto such a textile article, fourthly, as submitting textile ownership registration data, fifthly, as entering, filing, and storing such textile ownership registration data and, finally, as issuing proof of ownership of such a textile article for a new purchase or reissuing proof of ownership of such a textile article for a pre-owned purchase.

The method of textile ownership registration of the present invention can also be accomplished using a textile ID. Such a textile ID can be created by merging a textile model insignia and a textile ownership ID.

### BACKGROUND OF THE INVENTION

Although motor vehicle manufacturers produce many vehicles, motor vehicles are generally grouped by models. Furthermore, although different manufacturers use different model insignias to designate different vehicle models, a model insignia, nevertheless, is employed to display on a vehicle to identify a particular vehicle model. There is a link between a vehicle model and its financial value. Different models vary in different financial values. Thus, different model insignias indicate different price ranges. For examples, the 3-Series BMW models currently range about $30,000 to $40,000 and the S-CLASS Mercedes models currently range about $100,000 to $130,000. It might take some research and some familiarity to learn about the link between certain model insignias and certain price ranges, but without the use and the display of a model insignia on a motor vehicle, it would rather be difficult to guess the price range of any vehicle model. Like motor vehicles, textile articles do vary in price ranges. On the other hand, unlike motor vehicles, textile articles do not have any display of a model insignia on a surface area to indicate their financial values. Although the trademark and the logo are usually displayed on textile articles to infer to some type of financial status, especially of luxury fashion brands, they fail to pinpoint to the proximity of the price range of such textile articles. Until now, there have been no known cases where a textile model insignia is being employed, especially to indicate and to differentiate the financial values of textile articles. Since it is extremely more difficult to differentiate textile articles than vehicles due to their similar apparent physical features and due to the countless number of designers and the countless number of designs, it is nearly impossible for consumers to differentiate the financial values among so many textile articles without the use of a textile model insignia. There might be many advantages of displaying such a textile model insignia on a textile article. Some advantages may include an attempt to show off one's social status, an attempt to show off one's financial standing, and an attempt to show off one's fashion chic. Regardless of what advantage an owner of a textile article might be thinking of or benefiting from, the mere fact that a method of marking a textile model insignia onto a textile article, according to the present invention, to indicate and to differentiate the financial values among textile articles is useful enough.

During a manufacturing process of a motor vehicle, at least one vehicle ID is attached and bonded onto such a vehicle for identification purposes. When it is purchased, the motor vehicle is then registered to the new owner. A license plate is issued for visual identification. Furthermore, an ownership registration document (also known as a Pink Slip) is also issued for proof of ownership. The main reason for the vehicle ID is to provide identification and the vehicle registration is to provide proof of ownership. Other products such as electronic devices and machinery have similar product IDs and product registration, which are beneficial for product identification and proof of ownership, especially when a product has a high financial value. Like motor vehicles, electronic devices, and machinery, many textile articles, especially luxury fashion brands, come with high price tags. On the other hand, unlike motor vehicles, electronic devices, and machinery, textile articles do not have any display of a textile ownership ID or a textile ID for identification purposes and do not undergo any textile ownership registration for verification and proof of ownership. Until now, there have been no known cases where textile ownership registration with the help of a textile ownership ID or a textile ID is being employed for identification, verification, and proof of ownership purposes. Since it is extremely more difficult to differentiate among textile articles than vehicles, electronic devices, and machinery due to their similar apparent physical features and due to the countless number of designers and the countless number of designs, it is nearly impossible to differentiate textile articles without the use of a textile ownership ID or a textile ID and to verify textile ownership without the employment of textile ownership registration. There might be many advantages of textile ownership registration with the help of a textile ownership ID or a textile ID. Some advantages may include an attempt to discourage textile counterfeits, an attempt to discourage the trading of textile counterfeits, and an attempt to authenticate legitimate textile articles. Regardless of what advantage a fashion designer and/or an owner of a textile article might be thinking of or benefiting from, the mere fact that a method of textile ownership registration with the help of a textile ownership ID or a textile ID, according to the present invention, for identification, verification, and proof of ownership is useful enough.

The detailed explanations of a method of marking a textile model insignia, according to the present invention, are as follows:
Different price ranges are created. For examples, $1000-$1999.99, $2000-$2999.99, everything else in between, $100,000-$124,999.99, etc. so on and so forth.
Different textile model insignias are created. Since they can be any form, or any shape, or any combination thereof; textile model insignias can be symbols, or numbers, or alphabets, or any combination thereof, or anything that practical experience can advice. For examples, T1, T2, H1, H2, etc.
A different textile model insignia is assigned to and paired with each and every price range for correlation. For examples, assign T1 to $1000-$1999.99, T2: $2000-$2999.99, H1: $100,000-$124,999.99, etc.
An index is created to assign and to pair each textile model insignia to each and every price range for correlation. For examples,

| Price Ranges | Textile Model Insignias |
|---|---|
| $1000-$1999.99 | T1 |
| $2000-$2999.99 | T2 |
| $100,000-$124,999.99 | H1 |
| Etc. | Etc. |

Acknowledge the price of a textile article, wherein the said price can be a retail price, or a manufacturer's suggested retail price, or any price setting method that practical experience can advice. For example, MSRP of a handbag from designer A is $1950.
Identify the price range from the created index, wherein the said price of such a textile article falls within. For example, the said price of $1950 falls within $1000-$1999.99.
Identify the correlated textile model insignia from the created index that has been assigned to and paired with such a price range. For example, since the price range is $1000 and $1999.99, the textile model insignia T1 is identified.
Attach and bond such an identified textile model insignia, without the use of a label or using a label, onto such a textile article. For example, attach and bond T1 onto the handbag from designer A. Furthermore, attach and bond T1 to each and every textile article, regardless of the type of textile articles and regardless of fashion designers, if its price falls within the price range of $1000-$1999.99. For examples, apply T1 to boots from designer A, shoes from designer B, jackets from designer C, and coats from designer D where the prices fall between $1000-$1999.99.

The detailed explanations of a method of textile ownership registration with the help of a textile ownership ID, according to the present invention, are as follows:
Assign, attach and bond a textile ownership ID to a certain textile article, which can be done during a manufacturing process or any time such a textile article has been marketed. An example would be when a textile ownership ID, FABY3, has been assigned, attached and bonded to a handbag during a manufacturing process before it is released for market. Another example would be when new owner A makes a purchase of such a handbag without prior assignment, attachment and bonding of such a textile ownership ID.
At the time of purchase or any time afterward, owner A fills out and sends in all the necessary data for the textile ownership registration. If a textile ownership ID has not been assigned, attached and bonded to such a handbag at the time of purchase, a textile ownership ID, FABY3, would be assigned, attached and bonded to such a handbag after it is registered. Issuance of proof of ownership of such a handbag would be sent to owner A. Textile ownership registration data is entered, filed, and stored by a party, who is in charge of textile ownership registration, for verification purposes and issuance and reissuance of proof of ownership.

The detailed explanations of a method of textile ownership registration with the help of a textile ID, according to the present invention, are as follows:
Once a textile model insignia has been identified and a textile ownership ID has been created, merge such a textile model insignia and such a textile ownership ID into one textile ID. For example, since a textile model insignia is T1 and a textile ownership ID is FABY3, the textile ID would be T1FABY3.
Assign, attach and bond such a textile ID to a certain textile article, which can be done during a manufacturing process or any time such a textile article has been marketed. An example would be when T1FABY3 has been assigned, attached and bonded to a handbag during a manufacturing process before it is released for market. Another example would be when owner A makes a purchase of such a handbag without prior assignment, attachment and bonding of such a textile ID.
At the time of purchase or any time afterward, owner A fills out and sends in all the necessary data for the textile ownership registration. If a textile ID has not been assigned, attached and bonded to such a handbag at the time of purchase, the textile ID, T1FABY3, would be assigned, attached and bonded to such a handbag after it is registered. Issuance of proof of ownership of such a handbag would be sent to owner A. Textile ownership registration data is entered, filed, and stored by a party, who is in charge of textile ownership registration, for verification purposes and issuance and reissuance of proof of ownership.

In the tables and examples wherein in this patent, the letters, the numbers, the symbols, the price ranges, and the dollar amounts only represent examples of how certain textile model insignias and certain price ranges might appear on certain types of textile articles and by certain designers. They do not represent what textile model insignias only look like or which textile model insignias that this present invention is only claiming. They do not represent which textile articles that textile model insignias only appear in or which textile articles that this present invention is only claiming. They do not represent which price ranges that textile model insignias only appear in or which price ranges that this present invention is only claiming.

In the drawings, the figures only represent schematic displays of how certain textile model insignias, certain textile ownership IDs, and certain textile IDs might appear on certain textile articles. They do not represent what textile model insignias, what textile ownership IDs, and what textile IDs only look like. They do not represent which textile model insignias, which textile ownership IDs, and which textile IDs that this present invention is only claiming. They do not represent which textile articles that this present invention is only claiming. They do not represent what locations on which textile articles that textile model insignias, textile ownership IDs, and textile IDs only appear in.

It must be born in mind, in grouping textile articles by price ranges of the present invention, that price ranges may be grouped in any and all the variations that practical experience can advice, that prices of textile articles may be derived from retail prices, or manufacturer's suggested retail prices, or all the price setting methods that practical experience can advice, and that prices of textile articles may be set by any individual, or any entity, or any method that practical experience can advice so that they could be introduced in many variations since they remains all included in the spirit of the appended claims.

It must also be born in mind, in using the textile model insignias, textile ownership IDs, and textile IDs of the present invention, that it may be applied in any and all the variations that practical experience can advice, concerning forms, shapes, dimensions, color variations, methods, number of practical integrated pieces, and materials used in the same and further accessory circumstances, so that it may be introduced in many modifications that result consistent with the essential results, since it remains all included in the spirit of the appended claims.

It must also be born in mind, with textile ownership registration of the present invention, that it may be applied in any and all the variations that practical experience can advice, concerning the steps used for textile ownership registration, the methods used for textile ownership registration, and the process used for textile ownership registration, so that it may be introduced in many modifications that result consistent with the essential results, since it remains all included in the spirit of the appended claims.

### SUMMARY OF THE INVENTION

An object of the present invention is to attach and bond a textile model insignia onto a textile article through a method of marking a textile article. Such a method of marking a textile article is described as:
Creating various price ranges and various textile model insignias.
Assigning and pairing a different textile model insignia to each and every price range for correlation.
Acknowledging the price of a certain textile article.
Identifying the price range that such a price of such a textile article falls within.
Identifying the textile model insignia that is correlated to such a price range.
Displaying such a textile model insignia onto such a textile article and each and every other textile article, where its price falls within the same price range.

Another object of the present invention is to enable textile ownership registration with the help of a textile ownership ID or a textile ID. Such a method of textile ownership registration is described as:
Assign a textile ownership ID or a textile ID to a textile article.
Attach and bond such a textile ownership ID or a textile ID onto such a textile article.
Register such a textile article.
Issue or reissue proof of ownership of such a textile article.

### BRIEF DESCRIPTION OF THE DRAWINGS

The accompanying illustrations, in no means, limit this present invention only to the textile articles shown wherein, the price ranges shown wherein, the textile model insignias shown wherein, the textile ownership IDs shown wherein, the textile ID shown wherein, and the locations of placement of textile model insignias, textile ownership IDs, or textile ID shown wherein since they remain all included in the spirit of the appended claims.

FIG. 1 shows a textile model insignia displayed on an external surface area of a lady boot in accordance with the present invention.

FIG. 2 shows a textile ownership ID displayed on the internal surface area of a lady shoe in accordance with the present invention.

FIG. 3 shows a textile ownership ID displayed on an external surface area of a lady jacket in accordance with the present invention.

FIG. 4 shows a textile model insignia and a textile ownership ID displayed on an external surface area of a men shoe in accordance with the present invention.

FIG. 5 shows a textile ID displayed on an external surface area of a fragrance bottle in accordance with the present invention.

FIG. 6 shows a table, titled “Examples of Textile Model Insignia Designations”, in accordance with the present invention.

### DETAILED DESCRIPTION OF THE INVENTION

The followings are detailed descriptions of the illustrations. It is to be understood that the present invention is not limited only to the textile model insignias, the textile ownership IDs, and the textile ID shown or to the exact construction illustrated and described wherein, but that various changes and modifications may be made without departing from the spirit and the scope of the present invention as defined in the appended claims.

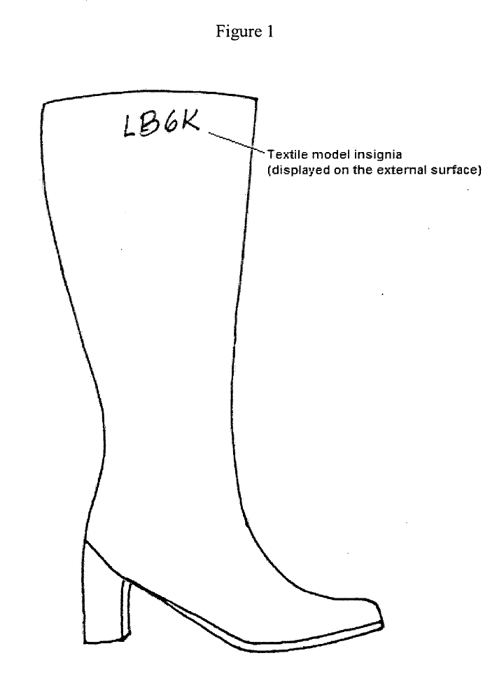

FIG. 1 shows a textile model insignia displayed on an external surface area of a lady boot in accordance with the present invention. The textile model insignia and the textile article shown are intended as an illustrated example only. The textile model insignia can be displayed on any external and/or internal surface area of any textile article. The use of the textile model insignia is defined in the appended claims.

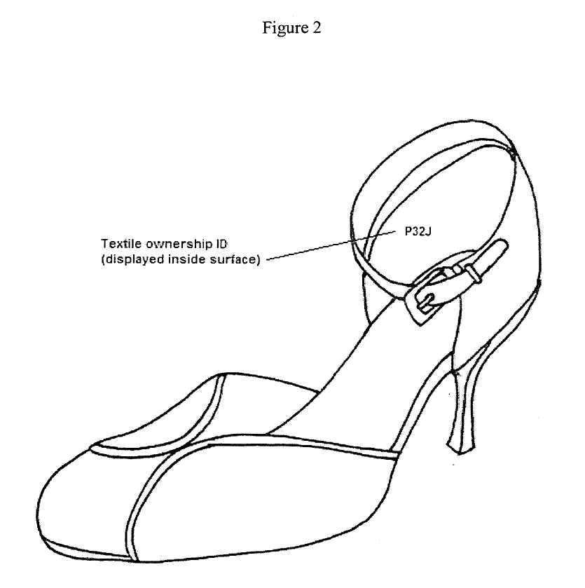

FIG. 2 shows a textile ownership ID displayed on the internal surface area of a lady shoe in accordance with the present invention. The textile ownership ID and the textile article shown are intended as an illustrated example only. The textile ownership ID can be displayed on any external and/or internal surface area of any textile article. The use of the textile ownership ID is defined in the appended claims.

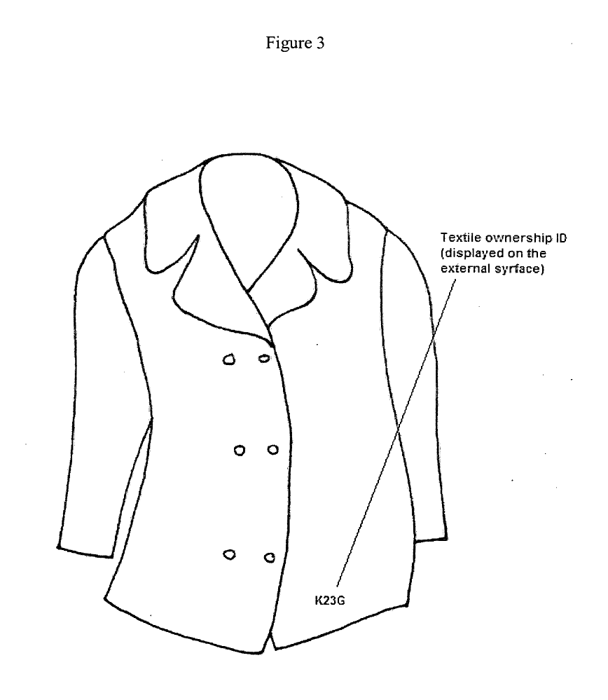

FIG. 3 shows a textile ownership ID displayed on an external surface area of a lady jacket in accordance with the present invention. The textile ownership ID and the textile article shown are intended as an illustrated example only. The textile ownership ID can be displayed on any external and/or internal surface area of any textile article. The use of the textile ownership ID is defined in the appended claims.

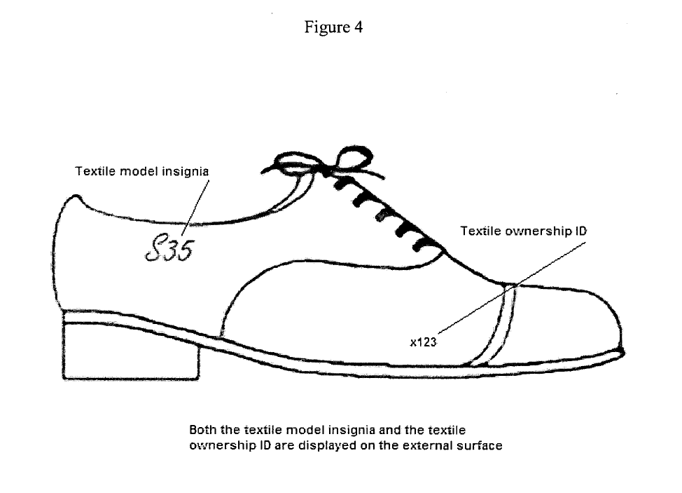

FIG. 4 shows a textile model insignia and a textile ownership ID displayed on an external surface area of a men shoe in accordance with the present invention. The textile model insignia, the textile ownership ID, and the textile article shown are intended as an illustrated example only. The textile model insignia and the textile ownership ID can be displayed on any external and/or internal surface area of any textile article. The use of the textile model insignia and the textile ownership ID is defined in the appended claims.

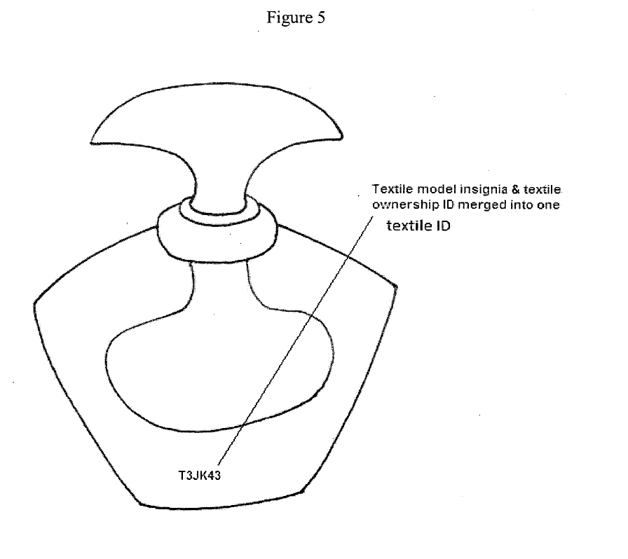

FIG. 5 shows a textile ID displayed on an external surface area of a fragrance bottle in accordance with the present invention. The textile ID and the textile article shown are intended as an illustrated example only. The textile ID can be displayed on any external and/or internal surface area of any textile article. The use of the textile ID is defined in the appended claims.

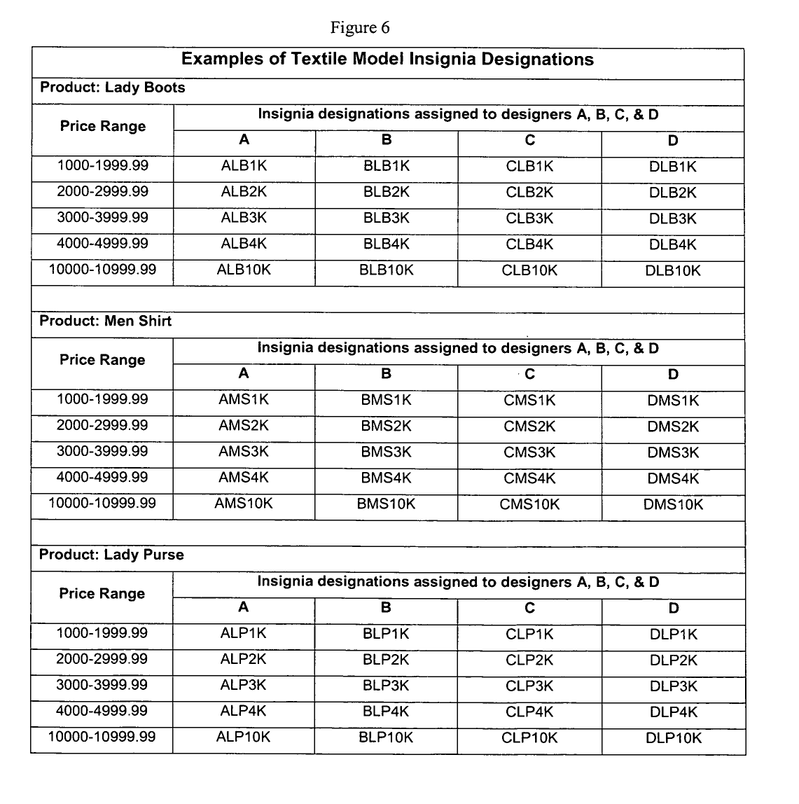

FIG. 6 shows the table, titled “Examples of Textile Model Insignia Designations”, in accordance with the present invention. The textile model insignias, the textile model insignia designations, the designers, the textile articles, and the price ranges shown are intended as an illustrated example only. The textile model insignia can be assigned to any textile article, or any designer, or any number of designers. The price ranges can be any denomination and of any arrangement. The use of the textile model insignia is defined in the appended claims.

What is claimed is:

1. A method of marking a textile model insignia onto a textile article comprising the steps of:
Creating a plurality of price ranges, which can be of any denomination and of any arrangement and which no two price ranges overlap one another;
Creating a plurality of textile model insignias, which can be of any form, or any shape, or any combination thereof and where no two textile model insignias are the same;
Creating an index, which can be in the form of a table, or a database, or similar, or any combination thereof, where a different textile model insignia is assigned to and paired with each and every price range for correlation, and where neither any textile model insignia correlates with any other price range nor any price range correlates with any other textile model insignia;
Providing a textile article, in which a certain price has been set;
Determining which price range from the created index that such a price of such a textile article falls within;
Identifying such a price range;
Identifying the correlated textile model insignia from the created index that has been assigned to and paired with such a price range;
Attaching and bonding such a textile model insignia, without the use of a label or using a label, onto such a textile article and each and every other textile article, in which its price falls within such a price range that is correlated to such a textile model insignia.

2. A method of textile ownership registration comprising the steps of:
Providing a textile article;
Creating a textile ownership ID, which can be of any form, or any shape, or any combination thereof, and where no two textile ownership IDs are the same;
Assigning such a textile ownership ID to such a textile article, where neither any textile ownership ID is assigned to any other textile article nor any textile article is assigned to any other textile ownership ID;
Attaching and bonding such a textile ownership ID onto such a textile article, without the use of a label or using a label, during a manufacturing process or any time such a textile article has been marketed;
Providing proof of purchase of such a textile article;
Providing a registration form, in the form of paper, or electronic, or any combination thereof;
Enabling textile ownership registration that may include the submission of such items as registration form, proof of purchase, and any other relevant data necessary for the textile ownership registration;
Entering, filing, and storing such textile ownership registration data, in the form of paper, or electronic, or any combination thereof, for textile ownership verification purposes;
Issuing proof of ownership of such a textile article, in the form of paper, or electronic, or any combination thereof, for a new purchase or reissuing proof of ownership of such a textile article, in the form of paper, or electronic, or any combination thereof, for a pre-owned purchase.

3. The method of textile ownership registration according to claim 2 using a textile ID, wherein such a textile ID is created by merging a textile model insignia according to claim 1 and a textile ownership ID according to claim 2.
